(19) United States
(12) Patent Application Publication
(10) Pub. No.: US 2008/0241299 A1
(43) Pub. Date: Oct. 2, 2008

(54) Electronic Device for Controlling Plastics Injection Molds

(76) Inventors: Maurizio Bazzo, Oderzo (IT); Dario Girelli, Brescia (IT)

Correspondence Address: FROMMER LAWRENCE & HAUG, 745 FIFTH AVENUE- 10TH FL., NEW YORK, NY, 10151, US

(21) Appl. No.: 12/040,370

(22) Filed: Feb. 29, 2008

(30) Foreign Application Priority Data
Mar. 2, 2007 (IT) TO2007U 000032

(51) Int. Cl. B29C 45/78; B29C 45/74; H05B 1/02; H05B 3/00

(52) U.S. Cl. 425/144; 219/201; 219/385; 219/424

(57) ABSTRACT

An electronic device for controlling plastics injection molds; the electronic device being completely separate and independent of the central temperature regulating control unit of the mold, and having a number of electronically controlled electric switching assemblies, each of which is interposable between one electric power module of the central temperature regulating control unit of the mold and the two independent resistors and two independent temperature sensors which together form each heating unit of the injection device of the mold; each electric switching assembly selectively and alternatively connecting one of the two resistors and one of the two temperature sensors of a corresponding heating unit to a respective electric power module of the central temperature regulating control unit of the mold; and the electronic device also having an electronic central control unit which controls the various electric switching assemblies as a function of the state of the resistors and temperature sensors of the various heating units.

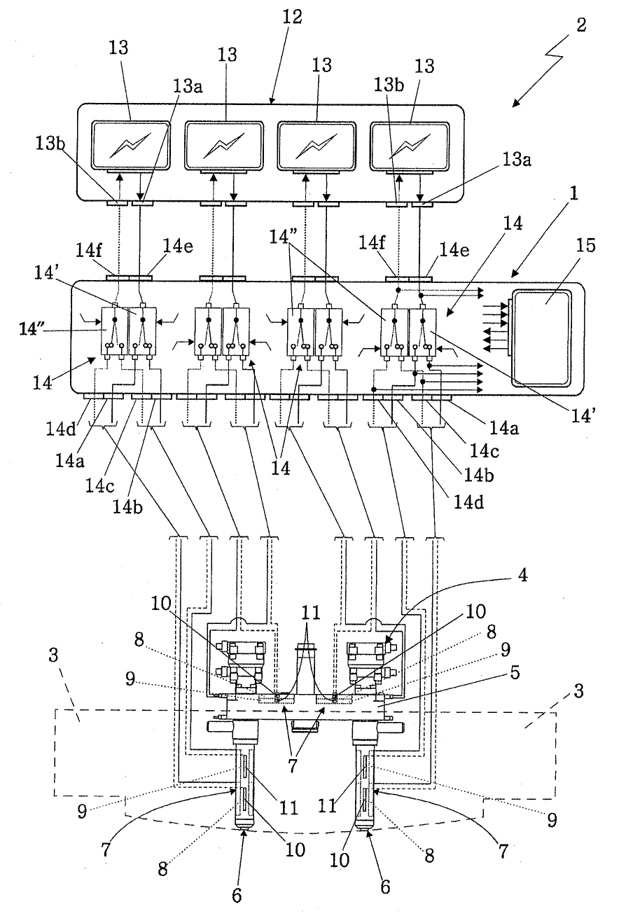

The present invention relates to an electronic device for controlling plastics injection molds.

More specifically, the present invention relates to an electronic device for controlling the electric power supply of plastics injection molds, and to a plastics injection mold comprising such a device.

### BACKGROUND OF THE INVENTION

As is known, plastics injection molds normally comprise at least two metal shells, which are closed cyclically one against the other, and are designed to form, at the mating surface, a closed cavity negatively reproducing the shape of the plastic article for molding; and an injection device, known as a “hot-channel device”, for injecting liquid plastic material and feeding the liquid plastic material in controlled manner to the central mold cavity.

More specifically, the hot-channel device is housed inside a seat formed in one of the two metal shells of the mold, and substantially comprises a hollow metal body, known as a “hot chamber”, which is filled continuously with liquid plastic material; a number of injectors extending from the “hot chamber” to the central mold cavity, and designed to regulate outflow of the liquid plastic material to the central mold cavity; and a number of electric heating units appropriately arranged along the hot-channel device shell defined by the “hot chamber” and the injectors, so as to Joule-heat the plastic material inside the hot-channel device.

In other words, the shell of the hot-channel device is divided into a number of independent electrically heated sections, each housing and heated by a respective electric heating unit.

Each heating unit normally comprises a resistor appropriately located inside the shell of the hot-channel device, i.e. in the “hot chamber” or one of the injectors forming the hot-channel device; and a thermocouple located close to the resistor to real-time measure the temperature of the portion of the hot-channel device about the resistor.

Which temperature obviously depends directly on the amount of Joule heat produced by the resistor and transmitted by conduction to the metal shell of the hot-channel device and to the plastic material inside the hot-channel device. The Joule heat produced by the resistor, in fact, is used to bring the plastic material inside the hot-channel device to, and keep it in, a liquid or semisolid state.

Finally, known plastics injection molds also comprise a central temperature regulating control unit which supplies electric energy independently to the resistor of each heating unit to keep the temperature of each electrically heated section of the hot-channel device at a predetermined reference value, depending on the electrically heated section.

More specifically, the central temperature regulating control unit comprises a number of independent electric power modules, each of which is connected to the thermocouple and resistor of a respective heating unit, and instantaneously regulates electric power supply to the resistor as a function of signals from the corresponding thermocouple, so as to keep the temperature of the portion of the heat-channel device close to the resistor at a predetermined reference value memorized beforehand in the central control unit.

The unreliability of the above solution is obvious, in that breakdown of even only one resistor impairs operation of the heat-channel device as a whole; and failure to heat even only a small portion of the metal shell of the heat-channel device allows the plastic material inside that portion to set, thus cutting off flow of the material to the central mold cavity.

To eliminate the above drawback, over the past few years, failsafe hot-channel devices have been devised, in which each heating unit comprises two independent resistors located close to each other in the shell of the hot-channel device; and two thermocouples, each located close to a corresponding resistor of the heating unit, to enable both thermocouples to measure the temperature about the two resistors.

In this case, each heating unit of the hot-channel device is connected to two separate electric power modules of the central temperature regulating control unit, which are activated alternatively so that one of the two resistors of the heating unit is always in a condition to keep the plastic material locally in the liquid state. Switching from one power module to the other is controlled by the central control unit by means of control logic, which detects any malfunctioning of the main resistor and/or main thermocouple of each heating unit.

Though highly reliable, failsafe hot-channel devices have the major drawback of requiring central temperature regulating control units in which the number of electric power modules is twice that of the electrically heated sections of the hot-channel device.

Which unfortunately results in a big increase in the purchasing cost of the mold: the electric power modules, in fact, are the most expensive part of the central temperature regulating control unit, the cost of which increases in proportion to the number of power modules, often even to the extent of being comparable with that of the failsafe hot-channel device as a whole.

To reduce the cost of the central temperature regulating control units, in recent years, two-channel electric power modules have been adopted, which are connected to both resistors and both thermocouples of the heating unit, and power the two resistors on the basis of electric signals from the two thermocouples.

This solution, however, has failed to bring about a real reduction in cost, on account of the control electronics required to simultaneously control two resistors and two thermocouples making two-channel electric power modules much more expensive than conventional types, and on account of the two-channel types failing to provide the same degree of reliability as conventional single-channel electric power modules.

### SUMMARY OF THE INVENTION

It is an object of the present invention to provide a plastics injection mold designed to provide the same degree of reliability as failsafe systems, but at lower cost as compared with known solutions.

According to the present invention, there is provided an electronic device for controlling plastics injection molds, as claimed in the attached Claims.

According to the present invention, there is also provided a plastics injection mold, as claimed in the attached Claims.

### BRIEF DESCRIPTION OF THE DRAWING

The present invention will be described with reference to the attached drawing, which shows schematically, and with parts removed for clarity, a plastics injection mold equipped with an electronic device for controlling plastics injection molds in accordance with the teachings of the present invention.

### DETAILED DESCRIPTION OF THE INVENTION

Number 1 in the attached drawing indicates as a whole an electronic device for controlling plastics injection molds and specially designed for connection to a plastics injection mold 2 comprising at least two metal shells 3 (only one shown in the drawing), which are closed cyclically one against the other, and are designed to form, at the mating surface, a closed cavity negatively reproducing the shape of the plastic article for molding. Mold 2 also comprises an injection device 4, known as a “hot-channel device”, for injecting liquid plastic material and feeding the liquid plastic material in controlled manner to the cavity formed by the two shells 3.

More specifically, injection device 4 is housed inside a seat formed in one of the two metal shells 3 of mold 2, on the opposite side to the mating surface with the other shell, and substantially comprises a hollow metal body 5, known as a “hot chamber”, which is filled continuously with liquid plastic material; one or more injectors 6 extending from hollow metal body 5 to the central cavity of shells 3, and designed to regulate outflow of the liquid plastic material to the cavity; and a number of electric heating units 7 appropriately arranged along the injection device shell defined by hollow metal body 5 and injectors 6, so as to Joule-heat the plastic material inside injection device 4.

In other words, the shell of liquid-plastic injection device 4 is divided into a number of independent electrically heated sections, each housing and heated by a respective electric heating unit 7.

Hollow metal body 5 and injectors 6 are commonly known devices in the industry, and therefore not described in detail.

Each heating unit 7, on the other hand, comprises two independent resistors 8 and 9 embedded close to each other inside the shell of injection device 4; and two independent thermocouples 10 and 11, or other similar temperature sensors, each of which is located close to a respective resistor 8, 9 of heating unit 7 to enable both thermocouples 10, 11 of heating unit 7 to instantaneously measure the temperature about resistors 8 and 9.

In other words, thermocouples 10 and 11 of each heating unit 7 of injection device 4 both provide for instantaneously measuring the temperature of the electrically heated section of injection device 4 in which heating unit 7 is housed.

In the example shown, the shell of injection device 4 is divided into four independent electrically heated sections, each housing and obviously heated by a respective heating unit 7.

With reference to the attached drawing, mold 2 also comprises a central temperature regulating control unit 12, which supplies electric energy independently to heating units 7 of injection device 4 to keep the temperature of each electrically heated section of injection device 4 at a predetermined reference value, depending on the electrically heated section in question.

More specifically, central temperature regulating control unit 12 is able to supply electric energy to either one of resistors 8 and 9 of each heating unit 7 by instantaneously regulating electric power supply to heating unit 7 as a function of signals from either one of thermocouples 10 and 11 of heating unit 7, so as to keep the temperature of each electrically heated section of injection device 4 at a corresponding predetermined reference value memorized in the central control unit itself.

In other words, central temperature regulating control unit 12 comprises a number of independent electric power modules 13, each of which supplies electric energy to one resistor 8, 9 of one heating unit 7 of injection device 4 by instantaneously regulating the electric power supply to resistor 8, 9 as a function of signals from one thermocouple 10, 11 of the same heating unit 7, so as to keep the temperature of the corresponding electrically heated section of injection device 4 at the corresponding reference value.

Unlike known solutions, however, central temperature regulating control unit 12 comprises a number of electric power modules 13 equal to the number of heating units 7 of injection device 4, i.e. the number of electrically heated sections into which liquid-plastic injection device 4 is divided.

With reference to the attached drawing, electronic device 1 is completely separate and independent of central temperature regulating control unit 12, and is interposed between central temperature regulating control unit 12 and heating units 7 of injection device 4 to control electric connection between heating units 7 and electric power modules 13 of central temperature regulating control unit 12.

More specifically, electronic device 1 comprises a number of electronically controlled electric switching assemblies 14, each of which is interposed between one heating unit 7 and one electric power module 13 of central temperature regulating control unit 12, and is designed to selectively and alternatively connect either one of resistors 8, 9 of heating unit 7 and either one of thermocouples 10, 11 of the same heating unit electrically to electric power module 13, without interfering with operation of central temperature regulating control unit 12.

In other words, electronic device 1 comprises a number of electric switching assemblies 14 equal to the number of heating units 7 of injection device 4.

More specifically, with reference to the attached drawing, each electric power module 13 of central temperature regulating control unit 12 has a power terminal 13a to which resistor 8, 9 of heating unit 7 is connectable; and a control terminal 13b to which thermocouple 10, 11 of the same heating unit 7 is connectable. And each electric switching assembly 14 has a first pair of input terminals 14a and 14b, each connectable electrically to a respective resistor 8, 9 of heating unit 7; a second pair of input terminals 14c and 14d, each connectable electrically to a respective thermocouple 10, 11 of heating unit 7; a first output terminal 14e connectable electrically to the power terminal 13a of the corresponding electric power module 13; and a second output terminal 14f connectable electrically to the control terminal 13b of the same electric power module 13. Each electric switching assembly 14 is designed, on command, to electrically connect its first output terminal 14e selectively and alternatively to either one of input terminals 14a and 14b, and to electrically connect its second output terminal 14f selectively and alternatively to either one of input terminals 14c and 14d of the same electric switching assembly 14.

With reference to the attached drawing, managing electronic device 1 also comprises an electronic central control unit 15 for controlling each electric switching assembly 14 as a function of the state of the two resistors 8, 9 and the two thermocouples 10, 11 of the heating unit 7 connected directly to the electric switching assembly.

More specifically, in the example shown, each electric switching assembly 14 comprises two electrically controlled two-way electric switches 14′ and 14″, each of which has two input terminals (obviously corresponding to the pair of input terminals 14a, 14b or 14c, 14d of electric switching assembly 14), and an output terminal (obviously corresponding to output terminal 14e or 14f of electric switching assembly 14) which is selectively and alternatively connectable electrically to either one of the input terminals.

Electric switch 14′ is interposed between power terminal 13a of electric power module 13 and the two resistors 8, 9 of heating unit 7; electric switch 14″ is interposed between control terminal 13b of electric power module 13 and the two thermocouples 10, 11 of the same heating unit 7; and electronic central control unit 15 controls the two electric switches 14′, 14″ of each electric switching assembly 14 separately.

Electronic central control unit 15 is connected to the input terminals of the two electric switches 14′, 14″ of each electric switching assembly 14 (i.e. is connected to input terminals 14a, 14b, 14c, 14d of each electric switching assembly 14) to acquire the electric signals travelling through the various electric switching assemblies 14 to the corresponding electric power modules 13, and processes these signals to real-time detect any malfunctioning of any one of resistors 8, 9 and/or thermocouples 10, 11 currently connected to the various electric power modules 13 of central temperature regulating control unit 12.

In the event of a faulty resistor 8, 9 and/or a faulty thermocouple 10, 11, electronic central control unit 15 switches the electric switching assembly 14 connected directly to the faulty component part of heating unit 7—i.e. switches the electric switch 14′, 14″ connected directly to the faulty component part of heating unit 7—to disconnect the faulty resistor 8, 9 and/or faulty thermocouple 10, 11 from the corresponding electric power module 13, and connect to it instead the other resistor 8, 9 and/or other thermocouple 10, 11 of the same heating unit 7; and all without interfering in any way with normal operation of central temperature regulating control unit 12.

In the example shown, managing electronic device 1 preferably, though not necessarily, also comprises acoustic and/or visual warning means (not shown), which are activated by electronic central control unit 15, alongside switching of any one of electric switching assemblies 14, to alert the operator of mold 2 to the existence of a faulty resistor 8, 9 and/or faulty thermocouple 10, 11.

Electronic central control unit 15 preferably, though not necessarily, is also designed to reconstruct the time pattern of power output by resistors 8, 9 of heating units 7 and/or the time pattern of the temperatures measured by thermocouples 10, 11 of heating units 7; to process the time patterns by means of appropriate statistical-analysis algorithms to determine any minor leakage of plastic material or other malfunctions of injection device 4; and to accordingly alert the operator and/or automatically shut down the press fitted with mold 2.

Operation of electronic device 1 and plastics injection mold 2 will be clear from the above description, with no further explanation required.

Electronic device 1 for controlling electric power supply to plastics injection molds obviously has numerous advantages.

In particular, electronic device 1 provides for appropriately powering a failsafe injection device 4 by means of a simplified central temperature regulating control unit 12 comprising a small number of single-channel electric power modules 13.

In other words, electronic device 1 provides for halving, i.e. reducing to a strict minimum, the number of electric power modules 13 of central temperature regulating control unit 12, thus enabling considerable saving in terms of cost.

Electronic device 1 as described also provides for further reducing the risk of forced stoppage of mold 2 with a failsafe injection device 4, by virtue of central temperature regulating control unit 12 regulating electric power supply to either one of resistors 8, 9 of each heating unit 7 as a function of signals from either one of thermocouples 10, 11 of the same heating unit 7. Which operating mode is impossible to achieve with conventional central temperature regulating control units, in which each heating unit of the failsafe injection device is connected permanently to two independent electric power modules, each supplying part of the heating unit.

Electronic device 1 is also extremely cheap to produce, by not having to dialog or interact directly with any part of mold 2, thus enabling the use of conventional, readily available, low-cost electronic components of proven reliability.

What is more, being totally passive, electronic device 1 requires no reconfiguration and/or replacement of any other parts of mold 2.

Clearly, changes may be made to electronic device 1, for controlling plastics injection molds 2, as described herein, without, however, departing from the scope of the present invention.

For example, electronic device 1 may comprise fewer electric switching assemblies 14 than the number of heating units 7 of injection device 4. In which case, obviously, central temperature regulating control unit 12 must be equipped with two electric power modules 13 for each heating unit 7 not connected to central temperature regulating control unit 12 by an electric switching assembly 14 of electronic device 1.

1) An electronic device for controlling plastics injection molds equipped with a liquid-plastic injection devices comprising a number of electric heating units, each of which comprises at least two independent resistors embedded close to each other inside the shell of the injection device, and at least two independent temperature sensors, each located close to a respective resistor said plastics injection molds also comprising a central temperature regulating control unit which supplies electric energy independently to each heating unit of the injection device said central temperature regulating control unit comprising a number of independent electric power modules, each of which supplies electric energy to one resistor of one heating unit by instantaneously regulating electric power supply to the resistor as a function of signals from either one of the temperature sensors of the same heating unit, and comprises a power terminal connectable to a resistor of the heating unit, and a control terminal connectable to a temperature sensor of the same heating unit;
said electronic device being completely separate and independent of said central temperature regulating control unit; and by comprising at least one electronically controlled electric switching assembly, which is interposable between one heating unit of the injection device and one electric power module of said central temperature regulating control unit, and is designed to selectively and alternatively connect either one of the resistors of said heating unit and either one of the thermocouples of the same heating unit electrically to said electric power module.

2) An electronic device as claimed in claim 1, wherein said at least one electric switching assembly comprises two first input terminals each connectable electrically to a respective resistor of said heating unit, two second input terminals each connectable electrically to a respective temperature sensor of said heating unit, a first output terminal connectable electrically to the power terminal of said electric power module, and a second output terminal connectable electrically to the control terminal of the same electric power module; said electric switching assembly being designed, on command, to electrically connect the first output terminal selectively and alternatively to either one of said first input terminals, and to electrically connect the second output terminal selectively and alternatively to either one of said second input terminals; said electronic device also comprising an electronic central control unit for controlling said at least one electric switching assembly as a function of the state of the two resistors and the two thermocouples of said heating unit.

3) An electronic device as claimed in claim 2, wherein said electronic central control unit processes the incoming electric signals to the first and second input terminals of said electric switching assembly to determine malfunctioning of the resistors and/or of the temperature sensor currently connected to the electric power module, and controls said electric switching assembly to disconnect the faulty resistor and/or the faulty temperature sensor from the electric power module, and replace it with the other resistor and/or the other temperature sensor of the same heating unitary.

4) An electronic device as claimed in claim 2, wherein the electronically controlled said electric switching assembly comprises two electrically controlled, two-way electric switches, each of which comprises two input terminals, and an output terminal which is selectively and alternatively connectable electrically to either one of the input terminals; a first two-way electric switch being interposed between the power terminal of said electric power module and the two resistors of said heating unit; and a second two-way electric switch being interposed between the control terminal of said electric power modules and the two temperature sensors of said heating unit.

5) An electronic device as claimed in claim 1, also comprising acoustic and/or visual warning means; said electronic central control unit activating said acoustic and/or visual warning means upon detecting malfunctioning of either one of the resistors and/or temperature sensors connected to said electric switching assembly.

6) An electronic device as claimed in claim 1, comprising a number of electric switching assemblies, each interposed between a respective heating unit and a corresponding electric power module of said central temperature regulating control unit; said electronic central control unit controlling each said electric switching assembly independently from the others, as a function of the state of the two resistors and two temperature sensors of the heating unit to which the electric switching assembly is connected.

7) A plastics injection mold comprising a managing electronic device as claimed in claim 1.

8) A plastics injection mold as claimed in claim 7, comprising a liquid-plastic injection devices for feeding plastic material in controlled manner to the cavity of the mold, and which comprises a number of heating units, each of which comprises at least two independent resistors embedded close to each other inside the shell of the injection device, and at least two independent temperature sensors, each located close to a respective resistor; said mold also comprising a central temperature regulating control unit which supplies electric energy independently to each heating unit of the injection device, and comprises a number of independent electric power modules, each of which supplies electric energy to one resistors of one heating unit by instantaneously regulating electric power supply to the resistor as a function of signals from either one of the temperature sensors of the same heating unit; the number of electric power modules being equal to the number of heating units of the injection device of said mold; and said managing electronic device comprising a number of electric switching assemblies equal to the number of heating units of the injection device of said molds, so that each electric power module is connected to a corresponding heating unit by a respective electric switching assembly.
